(19) United States
(12) Patent Application Publication
(10) Pub. No.: US 2009/0164228 A1
(43) Pub. Date: Jun. 25, 2009

(54) Methods and Systems For Strategy Deployment

(75) Inventors: Sheri Nemeth, Sherrills Ford, NC (US); Charles Michael Heath, Seneca, SC (US)

Correspondence Address: KILPATRICK STOCKTON LLP, 1001 WEST FOURTH STREET, WINSTON-SALEM, NC, 27101, US

(73) Assignee: Catalyst Business Systems, Inc., Sherrills Ford, NC (US)

(21) Appl. No.: 11/960,004

(22) Filed: Dec. 19, 2007

(51) Int. Cl. G06Q 90/00

(52) U.S. Cl. 705/1

(57) ABSTRACT

Methods and systems for strategy deployment are described. One embodiment includes a method having the steps of automatically generating a matrix associated with a business strategy, the matrix comprising a plurality of levels, each one of the plurality of levels comprising a plurality of directions, each one of the plurality of directions comprising a strategic item; automatically linking each one of the plurality of levels of the matrix associated with the strategic item; and causing the matrix to be displayed.

### FIELD OF THE INVENTION

The present invention relates to strategy deployment. The present invention more specifically relates to methods and systems for strategy deployment.

### BACKGROUND

One conventional method for strategy deployment typically involves manually updating and distributing strategic spreadsheets through an organization via email. For example, an Excel spreadsheet outlining one or more strategic objectives of a company may be manually updated by individual users and distributed to a team via an email. Such manual updating and distribution may create inconsistent data or versions of the spreadsheet, since updates may not be distributed to the entire group immediately, and individual users may edit an older out-of-date version of the spreadsheet.

### SUMMARY

Embodiments of the present invention comprise methods and systems for strategy deployment. In one embodiment of the present invention, a method comprises automatically generating a matrix associated with a business strategy, the matrix comprising a plurality of levels, each one of the plurality of levels comprising a plurality of directions, each one of the plurality of directions comprising a strategic item; automatically linking each one of the plurality of levels of the matrix associated with the strategic item; and causing the matrix to be displayed. In other embodiments, a computer-readable media comprises code for a carrying out such a method or other methods of the present invention.

These illustrative embodiments are mentioned not to limit or define the invention, but to provide examples to aid understanding thereof. Illustrative embodiments are discussed in the Detailed Description, and further description of the invention is provided there. Advantages offered by various embodiments of this invention may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIG. 1 is a block diagram illustrating a first system for strategy deployment according to one embodiment of the present invention;

FIG. 2 is a flow chart illustrating a first method for strategy deployment according to one embodiment of the present invention;

FIG. 3 is a flow chart illustrating a second method for strategy deployment according to one embodiment of the present invention;

FIG. 4 is a flow chart illustrating a third method for strategy deployment according to one embodiment of the present invention;

FIG. 5 is a first screen shot illustrating a display according to one embodiment of the present invention;

FIG. 6 is a is a second screen shot illustrating a display according to one embodiment of the present invention;

FIG. 7 is a third screen shot illustrating a display according to one embodiment of the present invention; and

FIG. 8 is a fourth screen shot illustrating a display according to one embodiment of the present invention.

### DETAILED DESCRIPTION

Embodiments of the present invention provide methods and systems for strategy deployment. Methods and systems according to the present invention may be embodied in a number of ways.

### Example of Strategy Deployment

In one illustrative embodiment of the present invention, users access strategy information through a web browser executing on a client computer. A remote portal running on a web server, or strategy server, provides access to strategy information stored in a database on the strategy server. The strategy server can automatically generate various strategy components, such as a strategy matrix, for display in the web browser on the client computer. The remote web portal may control access to the strategy information based on individual permission levels, and provide access to the various components through a dashboard or a tabbed interface. Strategy components such as a strategy matrix, listings, reports, and action plans facilitate accessing, viewing, and updating the strategy information.

In the embodiment, one strategy component, a strategy matrix, includes a plurality of levels. Each level of the strategy matrix includes four directions: north, east, south, and west. Each direction can include one or more strategic items, such as an annual objective item, an annual improvement priority item, a 3-5 year breakthrough item, a target to improve item, or a resource item. The strategy server may build a new matrix by prompting a user for at least one item for each direction, validating the items, and storing the items in a database.

Different levels of a strategy matrix can be linked through one or more common strategic items. When the strategic item is updated on one level of the matrix, the strategy server can automatically update every level of the strategy matrix associated with the strategic item. As one example, two levels of a strategy matrix include a strategic item in the form of an annual objective. When the annual objective is manually updated on one level of the strategy matrix, the strategy server automatically updates every other level of the strategy matrix associated with that annual objective.

This example is given to introduce the reader to the general subject matter discussed herein. The invention is not limited to this example. Further details regarding various embodiments of methods and systems for strategy deployment are described below.

### Illustrative Environment for Strategy Deployment

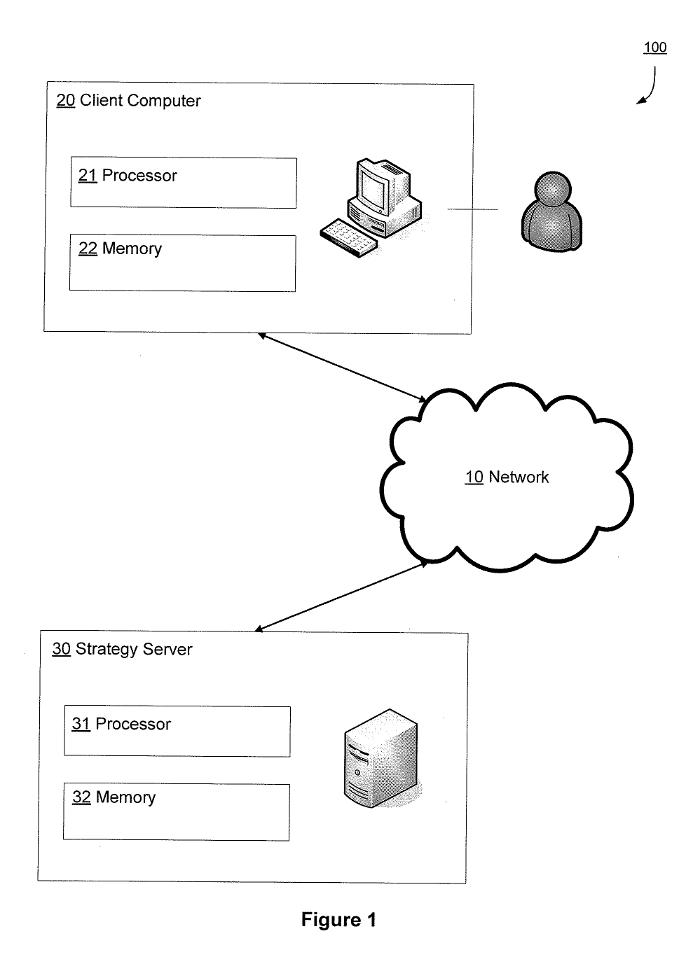

Referring now to the drawings in which like numerals refer to like elements throughout the several figures, FIG. 1 is a block diagram illustrating a first system for strategy deployment according to one embodiment of the present invention. Other systems may be utilized in various embodiments of the present invention. FIG. 1 is a block diagram illustrating a first system for strategy deployment according to one embodiment of the present invention.

The system 100 shown in FIG. 1 comprises a wired or wireless network 10 connecting a client computer 20 and a strategy server 30. Although in the embodiment shown in FIG. 1 only one client computer 20 is shown, many client computers may be in communication with the strategy server 30.

Client computer 20 comprises a processor 21 and a memory 22. Applications, such as a web browser, reside in memory 22 and may be executed by processor 21.

As is known to one of skill in the art, such applications may be resident in any suitable computer-readable medium and execute on any suitable processor. For example, the client computer device may comprise a computer-readable medium such as a random access memory (RAM) 22, coupled to a processor 21 that executes computer-executable program instructions stored in memory. Such processors may comprise a microprocessor, an ASIC, a state machine, or other processor, and can be any of a number of computer processors, such as processors from Intel Corporation of Santa Clara, Calif. and Motorola Corporation of Schaumburg, Ill. Such processors comprise, or may be in communication with, media, for example computer-readable media, which stores instructions that, when executed by the processor, cause the processor to perform the steps described herein.

Embodiments of computer-readable media comprise, but are not limited to, an electronic, optical, magnetic, or other storage or transmission device capable of providing a processor with computer-readable instructions. Other examples of suitable media comprise, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other devices that transmit or carry instructions to a computer, including a router, private or public network, or other transmission device or channel, both wired and wireless may also comprise various forms of computer-readable media. The instructions may comprise code from any suitable computer-programming language, including, for example, C, C++, C#, Visual Basic, Java, Python, Perl, and JavaScript.

In the embodiment shown in FIG. 1, the network 10 shown comprises the Internet. In other embodiments, other networks, such as an intranet, or no network may be used. The devices 20 and 30 can be connected to a network 10 as shown. Alternative configurations are possible. Communication over the network 10 may be facilitated by one or more communications protocols such as the Transmission Control Protocol (TCP) or the Internet Protocol (IP).

Examples of client computer 20 are personal computers, digital assistants, personal digital assistants, cellular phones, mobile phones, smart phones, pagers, digital tablets, laptop computers, Internet appliances, and other processor-based devices. In general, a client computer 20 may be any type of processor-based platform that operates on any operating system, such as Microsoft® Windows® or Linux, capable of supporting one or more client web browsing applications. Other applications may be stored in memory.

Such processors may comprise, or may be in communication with, media, for example computer-readable media, that may store instructions that, when executed by the processor, can cause the processor to perform the steps described herein as carried out, or assisted, by a processor. The processor, and the processing, described may be in one or more structures, and may be dispersed through one or more structures. The processor may comprise code for carrying out one or more of the methods (or parts of methods) described herein.

The client computer 20 may be in communication with the strategy server 30. In the embodiment shown, the strategy server 30 receives strategic information, such as information associated with a strategic item, from the client computer 20. The strategy server 30 may receive other information from the client computer 20, such as log-in information.

Strategy server 30 comprises a processor 31 and a memory 32. Applications such as a strategy deployment portal reside in memory 32 and may be executed by processor 31. The Strategy server may comprise a web server. Any standard web application server may be utilized, such as a Microsoft® Internet Information Server (“IIS”) or Apache. Strategy server 30 may be configured to receive strategic information from one or more client computers 20 and store the strategic information in a database in memory 32.

Strategy server 30 may be configured to generate various strategy components, including but not limited to a strategy matrix, an action plan, a bowling chart, or a report. Individual strategy components may comprise subcomponents. For example a bowling chart may comprise one or more countermeasures or a trend chart.

The strategy server 30 may generate strategy components and cause them to be displayed. In certain embodiments, the strategy server 30 may generate a web page comprising a strategy matrix for display on a web browser of a client computer 20. The strategy server 30 may also be configured to perform various tests on the strategic information stored in the database. For example, the strategy server 30 may validate a matrix by automatically checking the matrix for errors and completion. If the strategy server 30 determines that a matrix has errors or is incomplete, the strategy server 30 may generate an error report.

The strategy server 30 may be configured to generate other reports. As examples, the strategy server 30 may be configured to generate a target to improve performance report or a late report.

### Illustrative Embodiments of Methods of Strategy Deployment

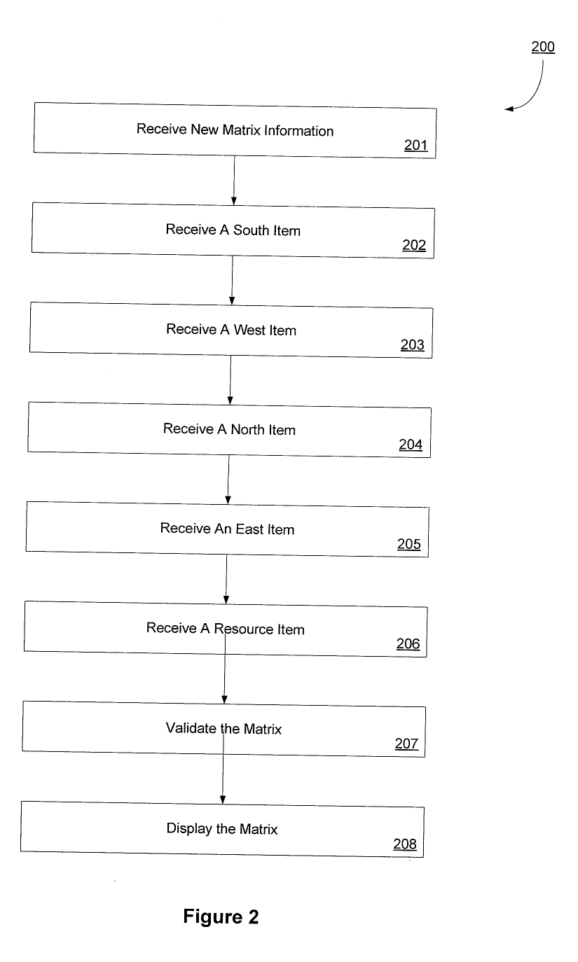

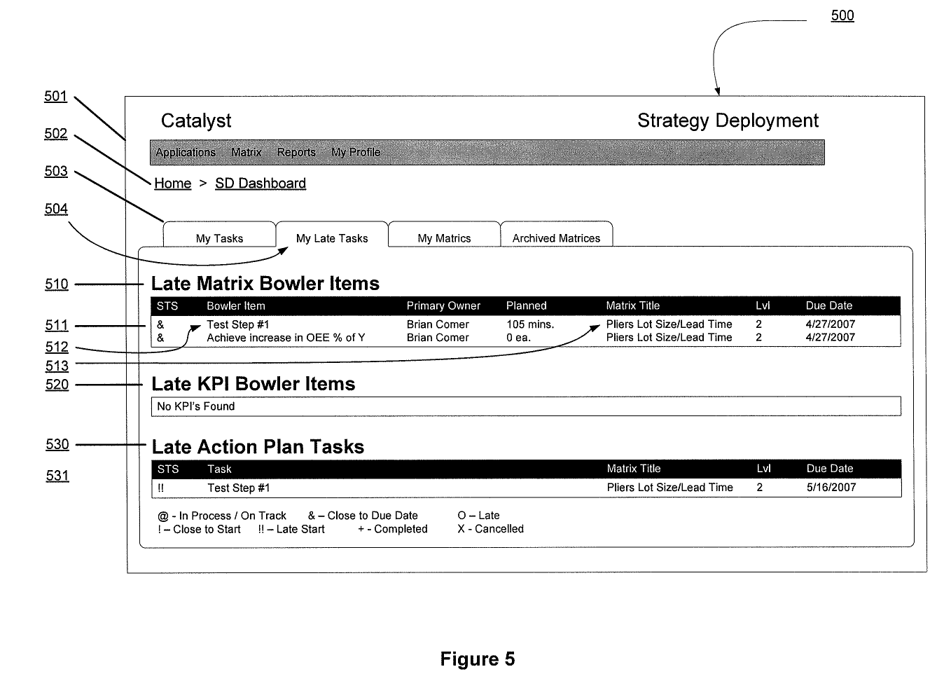

FIG. 2 is a flow chart illustrating a first method for strategy deployment according to one embodiment of the present invention. For purposes of illustration only, the elements of this method are described with reference to the system depicted in FIG. 1 and the screen shot depicted in FIG. 5. A variety of other implementations are also possible.

Method 200 illustrates the creation of a matrix. A matrix may be associated with a business strategy and comprise a plurality of levels. Each level of the matrix may comprise a plurality of directions, with each direction comprising one or more strategic items.

Each individual level of a matrix can be associated with a different degree of specificity in the overall business strategy. A low level of the matrix can show detailed information related to the production of a specific item. A higher level of the matrix, on the other hand, can show a “thirty thousand foot perspective” on the interrelation between different production lines and a corporate strategic objective.

The method 200 begins in block 201, where the strategy server 30 receives new matrix information. New matrix information may include data about the matrix, including, for example, a title of the matrix, an owner of the matrix, a division of the owner of the matrix, a start date, or and end date. The strategy server 30 may also receive information indicating whether the matrix is public or private. In the embodiment shown, a private matrix may only be edited and/or viewed by the matrix creator or owner. In contrast, a non-private matrix may be edited or viewed by an entire organization, or a division of the owner of the matrix. A non-private matrix may also be associated with an access list comprising users who may access the non-private matrix.

A local or global site administrator may manage the list of employees who have access to the strategic information. Further, the site administrator may manage the permission level of each user. Read and write privileges to strategic information or strategic components may be based at least in part on a permission level of a user.

In the illustrated embodiment of method 200, the strategy server 30 receives a south item 202, receives a west item 203, receives a north item 204, and receives an east item 205 after new matrix information is received 201. The south, west, north, and east items may be received in the order shown in method 200, or may be received in a different order. In one embodiment, the strategy server 30 receives a plurality of south items 202 before receiving a west item 203. In another embodiment, the strategy server 30 may receive a first south item, a first west item, and then receive a second south item.

Each direction of the strategy matrix may correlate with a strategic methodology. In one example, a level of the strategy matrix comprises five categories: when, what, how, how many, and who. The south direction is associated with when, the west direction is associated with what, the north direction is associated with how, the east direction is associated with how many, and a fifth category is associated with who. In this manner, a level of the strategy matrix may visually show a projected timeline, objectives for that timeline, strategies for achieving those objectives, metrics for measuring the progress of each strategy, and resources available to deliver each metric.

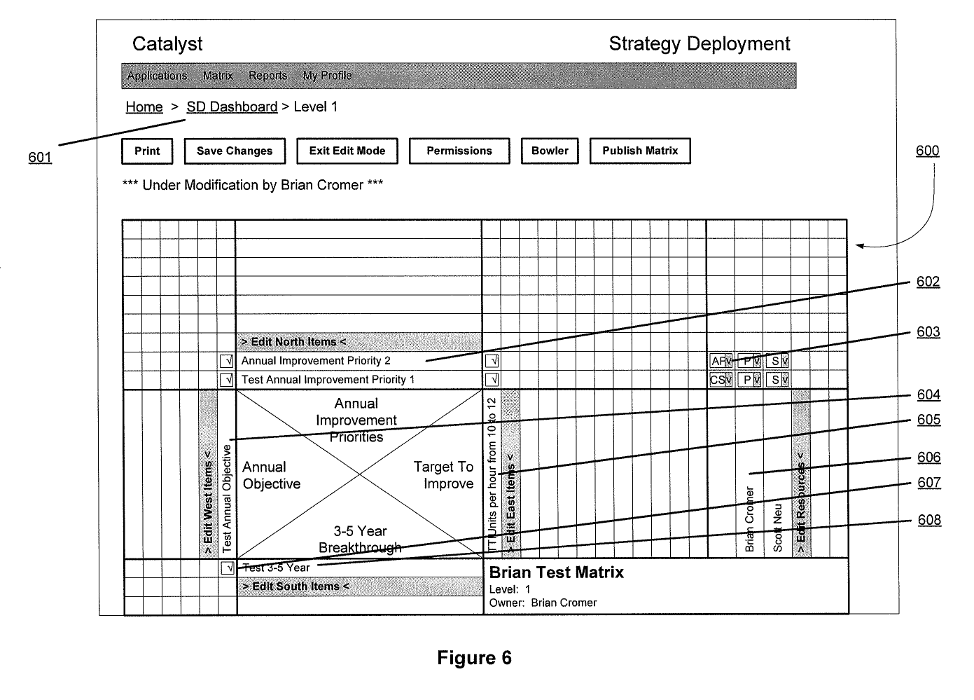

In the embodiment shown in FIG. 6, the strategy matrix is correlated to the Hoshin or Hoshin Kanri planning process. In certain other embodiments, a strategy matrix may be correlated to other strategic methodologies. Other methodologies may associate other directions of a matrix with various other categories.

After receiving the new matrix information, the strategy server 30 may receive a south item 202. A south item may be information associated with a three-to-five (3-5) year breakthrough. A breakthrough, or breakthrough improvement, may be associated with a certain type or grade of improvement. For example, a 3-5 year breakthrough may be contrasted with an incremental or a gradual improvement over the same time period.

The south direction can be associated with different breakthroughs. In one embodiment, the south direction is associated with the state of the organization in 5 to 20 years. As another example, the south direction may be associated with a general long-range vision. A strategic item, such as a south item, may comprise an item description.

In block 203, the strategy server 30 receives a west item. A west item comprises information associated with an objective, such as an annual objective. The west item may be associated with an objective of a different time frame, such as a monthly objective or a daily objective. An annual objective may comprise an item description. In other embodiments, the west direction is associated with a different category.

In block 204, the strategy server 30 receives a north item. The north direction can be associated with an annual improvement priority. In other embodiments, the north direction can be associated with monthly improvement priorities, daily improvement priorities, or other categories.

A north item received by the strategy server 30 may comprise information associated with the north direction, such as information associated with an annual improvement priority. An annual improvement priority may comprise an item description and an action. The action of an annual improvement priority may be an action plan or a cascade matrix. If an annual improvement priority comprises an action plan, the strategy server 30 may create a new action plan. Alternatively, if the action of an annual improvement priority is a cascade matrix, the strategy server 30 may create a new level of the matrix.

An annual improvement priority may be assigned a resource. In an embodiment, each annual improvement priority is assigned a primary and secondary resource. A resource may be a person capable of performing a task, or delivering a metric. Alternatively, a resource may comprise a mechanical object capable of performing one or more tasks.

In block 205, the strategy server 30 receives an east item. An east item may comprise information associated with a target to improve. A target to improve may comprise information such as an item description a jumping off point, a target, or a unit of measurement. In one example, a target may comprise widgets produced per year. The target to improve can be a specific amount by which to increase the number of widgets produced per year.

In block 206, the strategy server 30 receives a resource. In one example, a resource may be a person in a division. For example, a list of resources for each division, including persons in that division, may be stored in memory 32 of the strategy server 30. The strategy server 30 may display a listing of each resource in a division of a company following the selection of a specific division in a drop down list. One or more resources may be also assigned to an annual improvement priority.

The strategy server 30 may store other information not shown in FIG. 2. For example, the strategy server 30 may receive information linking two or more items together.

In block 207, the strategy server 30 validates the matrix. In one embodiment, the strategy server 30 may check the matrix for completeness. For instance, the strategy server can check a matrix for any incomplete or missing data. An incomplete matrix may comprise a matrix without at least one item in a direction. The strategy server 30 may also provide a summary of warnings, errors, or actions required after the matrix is published. Examples of required actions include adding a new action plan or adding a new level to the matrix.

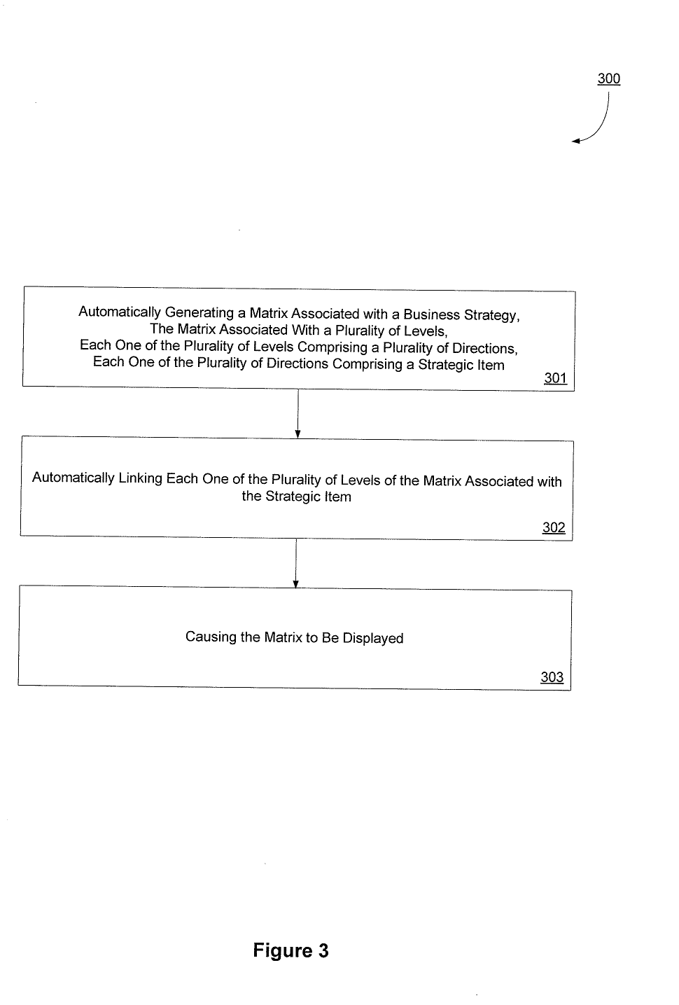

FIG. 3 is a flow chart illustrating a second method for strategy deployment according to one embodiment of the present invention. For purposes of illustration only, the elements of this method are described with reference to the system depicted in FIG. 1. A variety of other implementations are also possible.

The method 300 begins in block 301, where the strategy server 30 automatically generates a matrix associated with a business strategy, the matrix associated with a plurality of levels, each one of the plurality of levels comprising a plurality of directions, each one of the plurality of directions comprising a strategic item.

In block 302, the strategy server 30 automatically links each one of the plurality of the levels of the matrix associated with the strategic item. In one example, when an annual improvement priority item is edited, a cascade matrix may be created. Selecting a cascade matrix may result in creating a second level of the matrix. The strategy server 30 may automatically link the second level of the matrix with the first level of the matrix.

In one example, the strategy server 30 receives information linking a specific person, identified as a resource, with an annual improvement priority. The strategy server 30 then automatically creates a lower level, or cascade matrix. The strategy server 30 automatically links the cascade matrix with the upper level matrix. A user, such as the user associated with a resource linked to a cascade matrix, may determine that the annual improvement priority item of the cascade matrix needs to be cascaded to an additional level for further refinement. The strategy server 30 then creates a third level cascade matrix based on the strategic item that needs further refinement.

In block 303, the strategy server 30 causes a matrix to be displayed on a client computer 20. FIG. 6, for example, illustrates one embodiment of a matrix displayed on a client computer 20. The strategy server 30 can cause other information to be displayed alongside the matrix. For example, the strategy server may cause navigational tools, tabs, or menus to be displayed.

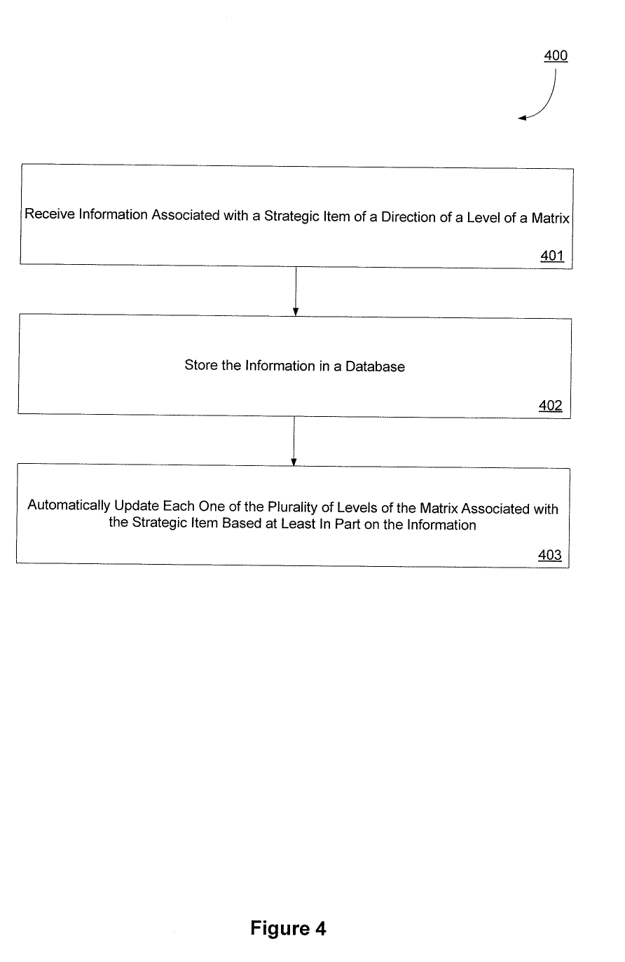

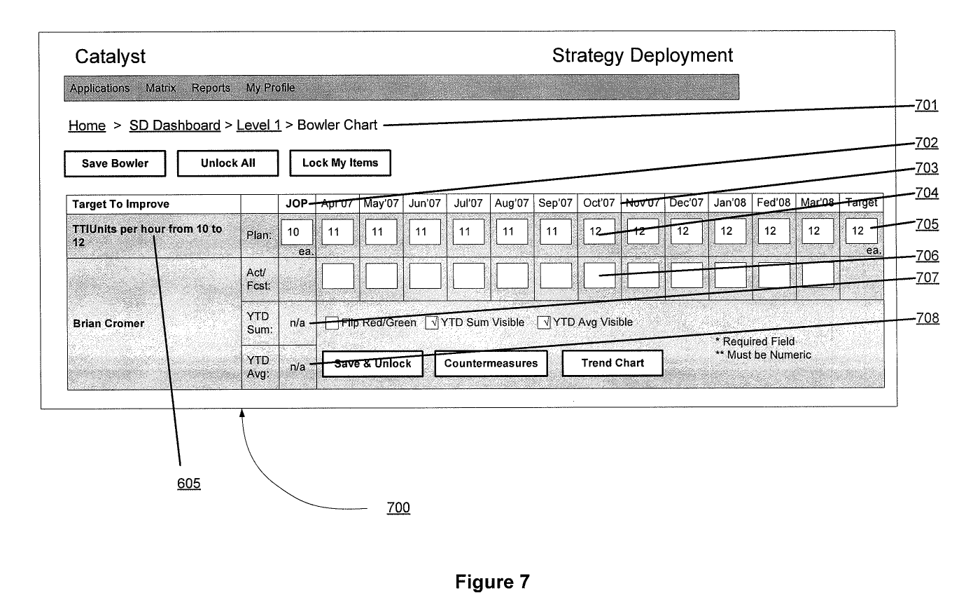

FIG. 4 is a flow chart illustrating a third method for strategy deployment according to one embodiment of the present invention. For purposes of illustration only, the elements of this method are described with reference to the system depicted in FIG. 1 and the screen shots depicted in FIGS. 6 and 7. A variety of other implementations are also possible.

Method 400 begins with block 401, where the strategy server 30 receives information associated with a strategic item of a direction of a level of a matrix. In one example, the strategy server 30 may receive a north item, such as an annual improvement priority 502, from a client computer 20.

The strategy server 30 may receive strategic information associated with other strategic components. As another example, the strategy server 30 can receive data related to a bowling chart. A bowling chart is a visual tool used to track periodic progress in quantitative terms. The blowing chart comprises strategic information such as an output goal or an actual output. By displaying actual output alongside output goals, the bowling chart can help organizations track actual performance over time, and compare performance with stated goals.

In block 402, the strategy server 30 stores the information in a database. The database, for example, may reside in memory 32 of the strategy server 30. By storing the information in a database on the strategy server, the strategic item may be automatically updated based at least in part on the information received by the strategy server 30.

In block 403, the strategy server 30 automatically updates each one of the plurality of levels of the matrix associated with the strategic item based at least in part on the information. The strategy server 30 may also automatically update bowling charts associated with the strategic item. For example, if target to improve 605 is updated to be 13 units per hour from 12 units per hour, bowling chart 700 may be automatically updated.

In one example, an annual objective of a top level may be updated from a $50 million revenue target to a $100 million revenue target. When this strategic item is updated on the top level, a lower level may be automatically updated. In such an example, on the lower level an annual objective to sell 50 widgets at $1 million per widget may be updated to reflect the top level revenue target, such as updating the objective to be selling 100 widgets at a price of $1 million per widget. In such an example, the top level of the matrix and the lower level of the matrix may be automatically linked based at least in part on a connection between each level's annual objective.

In some embodiments, the strategy server may send an alert to users associated with a matrix or a bowling chart when changes are made to the matrix or bowling chart. For example, if a manager updates a target to improve, the strategy server 30 may automatically generate and send an email to a line worker associated with the target to improve.

### Screen Shots of Methods for Strategy Deployment

FIGS. 5, 6, 7, and 8 are displays of screen shots according to embodiments of the present invention. Each display may be generated by a strategy server 30, and displayed by a web browser executing in a memory 21 of a client computer 20.

FIG. 5 is a first screen shot illustrating a display according to one embodiment of the present invention. The screen shot of FIG. 5 illustrates a view of a dashboard view 500.

The dashboard view 500 comprises navigation components 501, 502, and 503. Navigation menu 501 may be configured to provide access to applications, matrices, reports, and profiles.

The dashboard view 500 further comprises a bread crumb navigation trail 502. The bread crumb navigation trial may comprise a title of the current page being viewed, along with hyperlinks to one or more parent displays, or displays that a user visited before viewing the current page. The navigation trail 502 indicates that the current page is the Strategy Deployment (SD) Dashboard. Navigation trail 502 also comprises a hyperlink to the “Home” page.

The dashboard view 500 also comprises tabbed navigation component 503. Tabbed navigation component may comprise hyperlinked tabs configured to lead to several different pages. In the dashboard view 500, the tabbed navigation component 503 comprises links to My Tasks, My Late Tasks, My Matrices, All Matrices, and Archived Matrices. The “My Late Tasks” tab 504 is currently being viewed, as the tabbed navigation component 503 indicates by showing the tab 504 pulled to the front.

In the illustration, the “My Late Tasks” tab view comprises three lists: Late matrix bowler item list 510, Late key performance indicator (“KPI”) bowler item list 520, and late action plan task list 530. In other embodiments, the my late tasks tab view may comprise various other lists.

Each item listing may comprise a plurality of categories, such as a status, a bowler item name, a primary owner, a planed time, a matrix title, a level, or a due date. Category information may comprise text, graphical icons, or hyperlinks. For example, an item listing 511 comprises text, a yellow graphical icon status, text, a hyperlink to a bowler item 512, and a hyperlink to a matrix 513.

FIG. 6 is a second screen shot illustrating a display according to one embodiment of the present invention. Figure comprises a matrix view 600 of a first level, i.e. “Level 1” of a strategy matrix associated with a business strategy.

The display in FIG. 6 comprises navigation components such as navigation trail 601. As shown in FIG. 5, navigation trail 601 displays the current level of the matrix as the rightmost item. To the left of the current level name, the navigation trail 601 includes a hyperlink to the Strategy Deployment Dashboard and a hyperlink to the portal Home.

As illustrated in matrix view 600 comprises a plurality of directions. In the illustration, Level 1 comprises four directions: a north direction, a south direction, an east direction, and a west direction. Each direction shown in the illustration comprises at least one item. The north direction comprises an annual improvement priority item 602. The west direction comprises an annual objective item 604. The east direction comprises a target to improve item 605. The south direction comprises a 3-5 year breakthrough item 608.

One or more of the items in each direction may be linked together. In matrix view 600, a marked checkbox 607 may indicate that the south item “Test 3-5 Year” is linked with a west item “Test Annual Objective.” A strategic item of one direction may be linked to one or more items of one or more different directions. As one example, the annual improvement priority item 602 is illustrated to be linked to the west item 604 and the east item 605.

As shown in matrix view 600, Level 1 further comprises information related to one or more resources. In the embodiment shown, the resources for Level 1 of the matrix comprise a resource item 606 entitled “Brian Cromer.”

FIG. 7 is a third screen shot illustrating a display according to one embodiment of the present invention. FIG. 7 comprises a bowling chart view 700.

Bowling chart 700 may be based at least in part one of the plurality of levels of the matrix. More specifically, a strategy server 30 may generate a bowling chart based on a strategic item of one level of a matrix. In the embodiment shown, the bowling chart 700 is based on target to improve item 605, illustrated as improving the number of units per hour from 10 to 12.

The bowling chart 700 may comprise one or more of an output goal, a forecasted output, or an actual output. In the embodiment shown, the bowling chart comprises a target to improve 705. The output goal, or target to improve 705, is illustrated opposite a jumping off point (JOP) 702.

A bowling chart may also comprise one or more periodic targets 703. As shown in the screen shot, the bowling chart comprises twelve monthly periodic targets, including monthly periodic target 703 for October '07. In other embodiments, a bowling chart may comprise daily periodic targets, yearly periodic targets, or various other periodic targets. The number of periodic targets in a bowling chart may be based on the category for the north direction. In one example, if the north direction of one level of a strategy matrix comprises an annual improvement category, the number of periodic targets may total one year.

Twelve monthly periodic targets 703, representing a year of targets, separate the jumping off point 702 from the target to improve 704. In other embodiments, the bowling chart may comprise 52 weekly individual targets, or 365 daily individual targets. In certain other embodiments, the bowling chart may comprise 7 individual day targets, 24 individual hour targets, 31 individual day targets, 3 individual month targets, or various other numbers of individual targets.

Each periodic target 703 may comprise a planned output 704 and an actual or forecasted output 706.

Individual items or categories on the bowling chart may be hidden is visible. For example, in the bowling chart shown, a year to date sum 706 and a year to date average 707 are visible. In other embodiments of a bowling chart, one or both of these categories may be hidden.

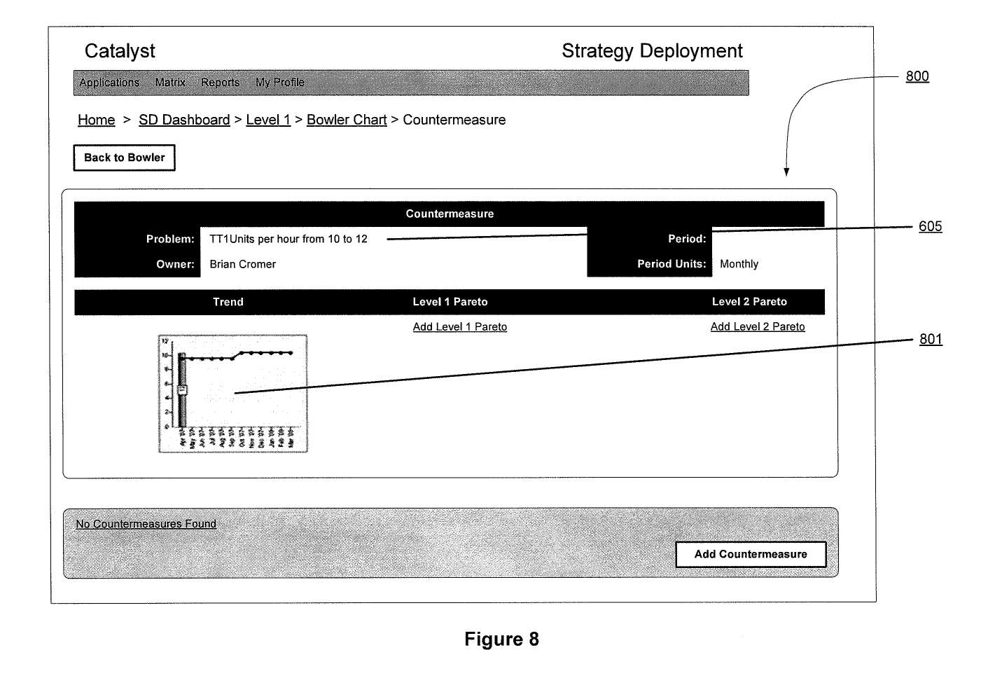

FIG. 8 is a fourth screen shot illustrating a display according to one embodiment of the present invention. FIG. 8 comprises a countermeasure view 800.

A countermeasure can include a problem, an owner, and a period. A problem may be a strategic item, such as a strategic item that has not been accomplished. For example, in the illustration shown, the countermeasure problem is strategic item 605.

Other strategic information may be associated with a countermeasure. For example, a countermeasure may comprise strategic information including a root cause, an impact, an owner, an owner's division, an item status, a percentage complete, a planned completion date, and notes.

Countermeasure view 800 also comprises a trend chart 801. Although FIG. 8 does not show a pareto chart, the countermeasure view may also comprise one or more pareto charts. A pareto chart or diagram can graphically summarize and display the relative importance of the differences between different groups

### Advantages of Strategy Deployment

Embodiments of the present invention provide various advantages over conventional methods for strategy deployment. Certain embodiments of the present invention may, for example, reduce or eliminate inefficiencies in the updating and distribution of a strategy. For example, one embodiment of the present invention may allow users to access a strategic plan which is stored and automatically updated on a central server, rather than manually updating and distributing a strategic plan in a file.

One advantage of an embodiment for strategy deployment is that strategic items associated with various levels of a strategy matrix may be automatically linked and updated. In contrast, conventional methods may require manual updates to each strategic item on each level of a matrix.

Automatically linking strategic items across different levels of a matrix may facilitate the accessibility and transparency of strategy information. A user may be able to select an individual strategic item on a high level of a strategy matrix, and quickly drill down to lower levels of the strategy matrix which are associated with the strategic item. The strategy server may automatically update each level of the matrix associated with a strategic item that is being edited. In contrast, conventional methods may suffer from slow speeds and complexity, since strategic information may be stored in individual, unconnected files distributed across a group or organization.

Because certain embodiments of the present invention are distributed, with access to the strategy information facilitated through a web browser connected to the Internet, methods of strategy deployment may be easy to access from any client computer with a web browser and access to the network. In contrast, other strategy deployment systems may be more difficult to access.

Another advantage of strategy deployment is that the method may be flexible and adapted to an individual business model of an individual client. Certain illustrated methods for strategy deployment may be scalable from small groups to large organizations. Conventional methods of enterprise resource planning may be slow to implement and difficult to adapt to the specific requirements of an individual client.

### General

The foregoing description of the embodiments, including preferred embodiments, of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the invention.

That which is claimed is:

1. A method comprising:
automatically generating a matrix associated with a business strategy, the matrix comprising a plurality of levels, each one of the plurality of levels comprising a plurality of directions, each one of the plurality of directions comprising a strategic item;
automatically linking each one of the plurality of levels of the matrix associated with the strategic item; and
causing the matrix to be displayed.

2. The method of claim 1, further comprising:
receiving information associated with the strategic item;
storing the information in a database; and
automatically updating each one of the plurality of levels of the matrix associated with the strategic item based at least in part on the information.

3. The method of claim 1, further comprising validating the matrix.

4. The method of claim 3, wherein validating the matrix comprises automatically checking the matrix for errors or completion.

5. The method of claim 1, further comprising generating an action plan based at least in part on the information related to the strategic item.

6. The method of claim 1, further comprising:
generating a bowling chart based at least in part on one of the plurality of levels of the matrix, and
automatically updating the bowling chart based at least in part on a change of the strategic item associated with the one of the plurality of levels.

7. The method of claim 6, wherein the bowling chart comprises one or more of an output goal, a forecasted output, or an actual output.

8. The method of claim 6, further comprising receiving countermeasure information associated with the bowling chart.

9. The method of claim 8, wherein the countermeasure information comprises a root cause or a task.

10. The method of claim 1, further comprising generating a report.

11. The method of claim 10, wherein the report provides a level of completion for a project, a summary of past due items from a bowling chart, a countermeasure, or an action plan.

12. The method of claim 10, wherein the report comprises a target to improve performance report or a late report.

13. The method of claim 1, further comprising causing a plurality of tabs to be displayed, each of the plurality of tabs corresponding with one of my tasks, my late tasks, my matrices, all matrices, or archived matrices.

14. The method of claim 1, wherein a first one of the plurality of directions comprises information related to one or more breakthrough descriptions.

15. The method of claim 1, wherein a second one of the plurality of directions comprises information related to one or more annual objectives.

16. The method of claim 1, wherein a third one of the plurality of directions comprises information related to one or more annual improvement priorities.

17. The method of claim 1, wherein a fourth one of the plurality of directions comprises information related to one or more targets to improve.

18. The method of claim 1, wherein at least one of the plurality of levels further comprises information related to one or more resources.

19. The method of claim 1, wherein access to one of the plurality of levels is based at least in part on a permission level of the user.

20. A computer-readable medium comprising program code, the program code comprising:
program code to automatically generate a matrix associated with a business strategy, the matrix comprising a plurality of levels, each one of the plurality of levels comprising a plurality of directions, each one of the plurality of directions comprising a strategic item;
program code to automatically link each one of the plurality of levels of the matrix associated with the strategic item; and
program code to cause the matrix to be displayed on a browser.

21. The computer-readable medium of claim 20, further comprising:
program code to receive information associated with a strategic item;
program code to store the information in a database; and
program code to automatically update each one of the plurality of levels of the matrix associated with the strategic item based at least in part on the information.

22. The computer-readable medium of claim 20, further comprising program code for validating the matrix.

23. The computer-readable medium of claim 20, further comprising program code to generate an action plan based at least in part on the information related to a business strategy.

24. The computer-readable medium of claim 20, further comprising program code to
generate a bowling chart based at least in part on one level of the plurality of levels of the matrix, and
program code to automatically update the bowling chart based at least in part on a change of a strategic item associated with the one level.

25. The computer-readable medium of claim 20, further comprising program code to generate a report.
